(19) United States
(12) Patent Application Publication
(10) Pub. No.: US 2019/0255815 A1
(43) Pub. Date: Aug. 22, 2019

(54) GLASS LAMINATES AND METHODS FOR FORMING THE SAME

(71) Applicant: Corning Incorporated, Corning, NY (US)

(72) Inventor: Louis Mattos, JR., Painted Post, NY (US)

(21) Appl. No.: 16/333,496

(22) PCT Filed: Sep. 13, 2017
(86) PCT No.: PCT/US17/51390

§ 371 Date: Mar. 14, 2019

Related U.S. Application Data
(60) Provisional application No. 62/394,475, filed on Sep. 14, 2016.

(51) Int. Cl. B32B 17/10; B32B 5/16; B32B 17/06

(52) U.S. Cl. CPC B32B 17/10816; B32B 5/16; B32B 17/062; B32B 17/1055; B32B 17/065; B32B 2260/028; B44C 5/0469; B32B 2262/067; B32B 2307/732; B32B 2451/00; B32B 2607/00; B32B 2479/00; B32B 2260/046

(57) ABSTRACT

A method includes pressing a stack including a glass sheet and an uncured non glass mat at a pressing pressure and a pressing temperature, whereby the uncured non¬glass mat is cured and bonded to the glass sheet to form a glass laminate including the glass sheet bonded to a non glass substrate. Another method includes pressing a stack including a glass sheet and a plurality of uncured polymer impregnated papers at a pressing pressure and a pressing temperature, whereby the plurality of uncured polymer impregnated papers is cured to form a non glass substrate and bonded to the glass sheet to form a glass laminate.

This application claims the benefit of priority to U.S. Provisional Application No. 62/394,475, filed on Sep. 14, 2016, the content of which is incorporated herein by reference in its entirety.

### BACKGROUND

### 1. Field

This disclosure relates to glass laminates, and more particularly to laminates including a glass sheet and a non-glass substrate bonded at elevated pressure and temperature.

### 2. Technical Background

High pressure laminate (HPL) materials generally include a plurality of polymer impregnated papers pressed at elevated pressure and temperature to bond the papers together into an integrated laminate structure. HPL materials generally are attached to a rigid substrate material such as plywood or medium density fiberboard (MDF).

Engineered wood materials such as chipboard, fiberboard, and plywood generally include a plurality of wood chips or fibers dispersed in a binder and pressed at elevated pressure and temperature to bond the wood fragments together into an integrated structure.

HPL materials and engineered wood materials can be used in applications such as furniture, countertops, cabinets, doors, and wall coverings.

### SUMMARY

Disclosed herein are glass laminates and methods for forming the same.

Disclosed herein is a method comprising pressing a stack comprising a glass sheet and an uncured non-glass mat at a pressing pressure and a pressing temperature, whereby the uncured non-glass mat is cured and bonded to the glass sheet to form a glass laminate comprising the glass sheet bonded to a non-glass substrate.

Disclosed herein is a method comprising pressing a stack comprising a glass sheet and a plurality of uncured polymer impregnated papers at a pressing pressure and a pressing temperature, whereby the plurality of uncured polymer impregnated papers is cured to form a non-glass substrate and bonded to the glass sheet to form a glass laminate.

It is to be understood that both the foregoing general description and the following detailed description are merely exemplary, and are intended to provide an overview or framework to understanding the nature and character of the claimed subject matter. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic cross-sectional view of a glass laminate according to some embodiments.

FIG. 2 is an exploded schematic cross-sectional view of the glass laminate of FIG. 1.

FIGS. 3-5 are schematic illustrations of one exemplary method for forming the glass laminate of FIG. 1.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

In various embodiments, a glass laminate comprises a glass sheet bonded to a non-glass substrate. In some embodiments, the non-glass substrate is a high pressure laminate (HPL) material, a low pressure laminate (LPL) material, or a continuous pressure laminate (CPL) material. In other embodiments, the non-glass substrate is a chipboard material, a fiberboard material, or a plywood material.

In various embodiments, a method comprises pressing a stack comprising a glass sheet and an uncured non-glass mat at a pressing pressure and a pressing temperature, whereby the uncured non-glass mat is cured to form a non-glass substrate and bonded to the glass sheet to form a glass laminate comprising the glass sheet bonded to the non-glass substrate. In some embodiments, the pressing pressure is at least about 1 MPa. Additionally, or alternatively, the pressing temperature is at least about 100° C. In some embodiments, the uncured non-glass mat comprises a plurality of polymer impregnated papers. In some of such embodiments, the non-glass substrate is a high pressure laminate (HPL) material, a low pressure laminate (LPL) material, or a continuous pressure laminate (CPL) material. For example, the method comprises pressing a stack comprising a glass sheet and a plurality of polymer impregnated papers at a pressing pressure of at least about 1 MPa and a pressing temperature of at least about 100° C., whereby the glass sheet and the plurality of polymer impregnated papers are bonded to form a glass laminate. In other embodiments, the uncured non-glass mat comprises wood fragments dispersed in a binder. In some of such embodiments, the non-glass substrate is a chipboard material, a fiberboard material, or a plywood material. For example, the method comprises pressing a stack comprising a glass sheet and a plurality of wood fragments dispersed in a binder at a pressing pressure of at least about 1 MPa and a pressing temperature of at least about 100° C., whereby the glass sheet and the plurality of wood fragments are bonded to form a glass laminate.

Surprisingly, the glass sheet is capable of withstanding the elevated pressure and temperature used to simultaneously cure the uncured non-glass mat to form the non-glass substrate and bond the glass sheet to the non-glass substrate, even when the glass sheet is a flexible glass sheet with a thickness of 0.3 mm or less. Forming the non-glass substrate and bonding the glass sheet to the non-glass substrate in a single process can reduce the time and cost of producing a glass laminate compared to processes in which the non-glass substrate is formed in a forming step and the glass sheet is laminated to the previously formed non-glass substrate in a separate lamination step.

In various embodiments described herein, an uncured non-glass mat is pressed at a pressing pressure and a pressing temperature sufficient to cure the uncured non-glass mat to form a non-glass substrate. The uncured non-glass mat can be relatively tacky or less viscous compared to the non-glass substrate, e.g., as a result of less cross-linking compared to the non-glass substrate. For example, in some embodiments, the uncured non-glass mat is a liquid composition, and after such curing, an applied film of the composition is at least set-to-touch as defined in ASTM D895-Standard Test Methods for Evaluating Drying or Curing During Film Formation of Organic Coatings Using Mechanical Recorder, which is incorporated herein by reference in its entirety. Such curing can be a result, for example, of crosslinking or chain-extension reactions that take place during the pressing.

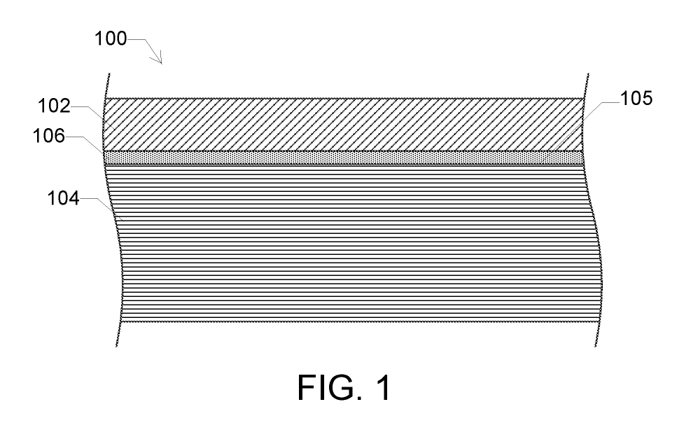

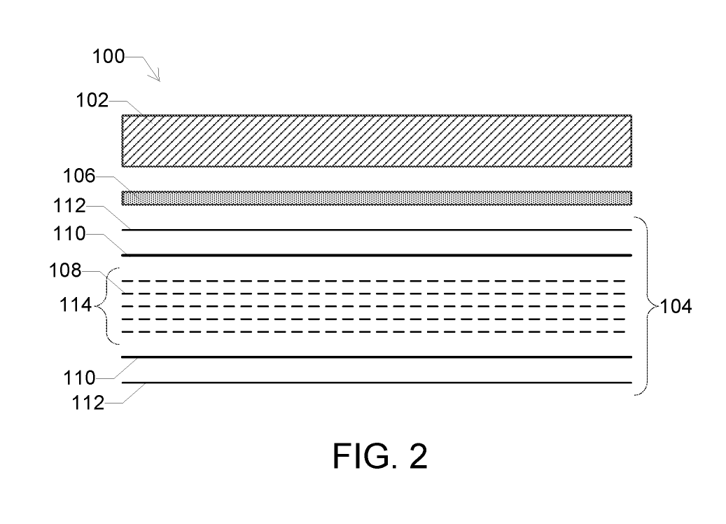

FIGS. 1 and 2 are schematic cross-sectional and exploded schematic cross-sectional views, respectively, of one embodiment of a glass laminate 100. Glass laminate 100 comprises a glass sheet 102 bonded to a non-glass substrate 104. For example, glass sheet 102 is bonded to a surface 105 of non-glass substrate 104. In some embodiments, glass sheet 102 is bonded to non-glass substrate 104 with an adhesive 106 as shown in FIGS. 1-2. In other embodiments, the adhesive is omitted such that the glass sheet is bonded directly to the non-glass substrate. For example, the glass sheet can be bonded directly to the non-glass substrate with the polymer, binder, or resin of the non-glass substrate as described herein.

In various embodiments, glass sheet 102 is formed from or comprises a glass material, a ceramic material, a glass-ceramic material, or a combination thereof. For example, glass sheet 102 is a flexible glass sheet commercially available under the trade name Corning® Willow® Glass (Corning Incorporated, Corning, N.Y., USA) or a chemically strengthened glass sheet commercially available under the trade name Corning® Gorilla® Glass (Corning Incorporated, Corning, N.Y., USA). Glass sheet 102 can be formed using a suitable forming process such as, for example, a downdraw process (e.g., a fusion draw process or a slot draw process), a float process, an updraw process, or a rolling process. Glass sheets produced using a fusion draw process generally have surfaces with superior flatness and smoothness when compared to glass sheets produced by other methods. The fusion draw process is described in U.S. Pat. Nos. 3,338,696 and 3,682,609, each of which is incorporated by reference herein in its entirety.

In some embodiments, glass sheet 102 comprises anti-microbial properties. For example, glass sheet 102 comprises a sufficient silver ion concentration at the surface of the glass sheet to exhibit anti-microbial properties (e.g., in the range from greater than 0 to 0.047 μg/cm²) as described in U.S. Patent Application Publication No. 2012/0034435, which is incorporated by reference herein in its entirety. Additionally, or alternatively, glass sheet 102 is coated with a glaze comprising silver, or otherwise doped with silver ions, to exhibit anti-microbial properties as described in U.S. Patent Application Publication No. 2011/0081542, which is incorporated by reference herein in its entirety. In some embodiments, glass sheet 102 comprises about 50 mol % SiO₂, about 25 mol % CaO, and about 25 mol % Na₂O to exhibit anti-microbial properties.

In some embodiments, a thickness of glass sheet 102 is at least about 0.01 mm, at least about 0.02 mm, at least about 0.03 mm, at least about 0.04 mm, at least about 0.05 mm, at least about 0.06 mm, at least about 0.07 mm, at least about 0.08 mm, at least about 0.09 mm, at least about 0.1 mm, at least about 0.2 mm, at least about 0.3 mm, at least about 0.4 mm, or at least about 0.5 mm. Additionally, or alternatively, a thickness of glass sheet 102 is at most about 3 mm, at most about 2 mm, at most about 1 mm, at most about 0.7 mm, at most about 0.5 mm, at most about 0.3 mm, at most about 0.2 mm, or at most about 0.1 mm. In some embodiments, glass sheet 102 is a flexible glass sheet. For example, the thickness of glass sheet 102 is at most about 0.3 mm. Additionally, or alternatively, glass sheet 102 is a strengthened glass sheet (e.g., a thermally tempered or chemically strengthened glass sheet). For example, the thickness of glass sheet 102 is about 0.4 mm to about 3 mm.

In various embodiments, non-glass substrate 104 is formed from or comprises primarily non-glass materials. For example, non-glass substrate 104 comprises wood-based materials (e.g., wood, chipboard, particleboard, fiberboard, hardboard, cardboard, and/or paper), polymeric materials, and/or metal materials. In some embodiments, non-glass substrate 104 comprises glass, glass-ceramic, and/or ceramic materials as secondary constituents (e.g., fillers). However, in such embodiments, non-glass substrate 104 is free of glass, glass-ceramic, or ceramic sheets (e.g., solid or substantially solid sheets as opposed to fibrous mats or weaves).

In some embodiments, non-glass substrate 104 is formed from or comprises one or more layers of polymer-impregnated paper. For example, in the embodiment shown in FIGS. 1-2, non-glass substrate 104 comprises a plurality of polymer impregnated papers. In some embodiments, the plurality of polymer impregnated papers is a HPL material, a LPL material, or a CPL material. For example, the plurality of polymer impregnated papers comprises one or more core papers 108, one or more decorative papers 110, and/or one or more surface papers 112. In some embodiments, core papers 108 are kraft papers impregnated with a phenolic resin. Core papers 108 form a core 114 of non-glass substrate 104, which can comprise a majority of a thickness of the non-glass substrate as shown in FIG. 2. Additionally, or alternatively, a decorative paper 110 is disposed on an outer surface of core 114 of non-glass substrate 104. In some embodiments, decorative paper 110 comprises a pair of decorative papers, and one of the pair of decorative papers is disposed on each of opposing outer surfaces of core 114 as shown in FIG. 2. In some embodiments, decorative papers 110 comprise a decoration that is visible through glass sheet 102 or at a non-glass surface of glass laminate 100 opposite the glass sheet. For example, the decoration comprises a solid color, a decorative pattern, or an image (e.g., printed on outer surfaces of the decorative papers). In some embodiments, decorative papers 110 are kraft papers impregnated with a phenolic resin and/or a melamine resin. Additionally, or alternatively, a surface paper 112 is disposed on an outer surface of decorative paper 110. In some embodiments, surface paper 112 comprises a pair of surface papers, and one of the pair of surface papers is disposed on an outer surface of each of the pair of decorative papers as shown in FIG. 2. Thus, each of the pair of decorative papers 110 is disposed between the respective surface paper 112 and core 114. In some embodiments, surface papers 112 are tissue or kraft papers impregnated with a melamine resin. Surface papers 112 can be sufficiently thin that the underlying decorative papers 110 are visible through the surface papers, but sufficiently resilient to protect the underlying decorative papers. The plurality of polymer impregnated papers can be pressed with the glass sheet at elevated temperature and pressure to cure the polymer and form the glass laminate as described herein.

Surface papers 112 impregnated with melamine resin can provide a damage-resistant surface that can help to protect the underlying decorative papers 110. Thus, in embodiments in which the decorative paper is impregnated with a melamine resin, the respective surface layer can be omitted. Additionally, or alternatively, the surface layer that would otherwise be disposed between the glass sheet and the core of the non-glass substrate can be omitted because the glass sheet can serve as the protective layer for the underlying decorative paper. Thus, in some embodiments, the glass laminate comprises a surface layer disposed at the non-glass surface of the non-glass substrate remote from the glass sheet and is free of a surface layer disposed at the glass surface of the non-glass substrate closest to the glass sheet.

In some embodiments, the non-glass substrate comprises a functional layer in addition to the polymer impregnated papers. For example, the functional layer comprises one or more moisture barrier layers embedded within the polymer impregnated papers to prevent moisture from penetrating into the non-glass substrate. The moisture barrier layers can be formed from or comprise a metal, a polymer, or combinations thereof.

In some embodiments, a thickness of non-glass substrate 104 is at least about 1 mm, at least about 2 mm, at least about 3 mm, at least about 4 mm, at least about 5 mm, at least about 6 mm, at least about 7 mm, at least about 8 mm, at least about 9 mm, or at least about 10 mm. Additionally, or alternatively, the thickness of non-glass substrate 104 is at most about 100 mm, at most about 90 mm, at most about 80 mm, at most about 70 mm, at most about 60 mm, at most about 50 mm, at most about 40 mm, at most about 30 mm, at most about 29 mm, at most about 28 mm, at most about 27 mm, at most about 26 mm, at most about 25 mm, at most about 24 mm, at most about 23 mm, at most about 22 mm, at most about 21 mm, or at most about 20 mm.

Although non-glass substrate 104 described with reference to FIGS. 1-2 comprises a plurality of polymer impregnated papers, other embodiments are included in this disclosure. In other embodiments, the non-glass substrate is formed from or comprises a wood-based material comprising wood fragments dispersed in a binder. In some embodiments, the wood fragments comprise wood particles, wood chips, and/or wood fibers. Additionally, or alternatively, the binder comprises a resin that binds the wood fragments. For example, in some embodiments, the binder comprises a resin selected from the group consisting of a urea-formaldehyde (UF) resin, a phenol formaldehyde (PF) resin, a melamine-formaldehyde (MF) resin, a methylene diphenyl diisocyanate (MDI) resin, a polyurethane (PU) resin, compatible mixtures thereof, and compatible combinations thereof. In some embodiments, the non-glass substrate is a chipboard material, a fiberboard material (e.g., particleboard, medium density fiberboard (MDF), or hardboard), or a plywood material. For example, the non-glass substrate is a wood-based panel such as a chipboard panel, a fiberboard panel (e.g., a particleboard panel, a MDF panel, or a hardboard panel), or a plywood panel. Additionally, or alternatively, the wood-based panel comprises a decoration that is visible through the glass sheet or at a non-glass surface of the glass laminate opposite the glass sheet. For example the decoration comprises a decorative layer (e.g., a decorative paper or polymer), ink or paint, or a veneer disposed at an outer surface of the wood-based panel. The wood fragments and binder can be pressed with the glass sheet at elevated temperature and pressure to cure the binder and form the glass laminate as described herein.

In various embodiments, adhesive 106 is formed from or comprises a polymeric material. In some embodiments, adhesive 106 comprises a polymeric material selected from the group consisting of a silicone, an acrylate (e.g., polymethyl methacrylate (PMMA)), a polyurethane polyvinylbutyrate, an ethylenevinylacetate, an ionomer, a polyvinyl butyral, compatible mixtures thereof, and compatible combinations thereof. For example, adhesive 106 comprises DuPont SentryGlas®, DuPont PV 5411, Japan World Corporation material FAS, or polyvinyl butyral resin. In some embodiments, adhesive 106 comprises a thermoplastic polymer material. Additionally, or alternatively, adhesive 106 is a sheet or film of adhesive that can be included in a stack between glass sheet 102 and non-glass substrate 104 and pressed at elevated temperature and pressure to bond the glass sheet and the non-glass substrate and form the glass laminate as described herein. In some of such embodiments, adhesive 106 comprises a decorative pattern or design visible through glass sheet 102. In some embodiments, adhesive 106 comprises a functional component that exhibits, for example, color, decoration, heat or UV resistance, IR filtration, or combinations thereof. Additionally, or alternatively, adhesive 106 is optically clear on cure, translucent, or opaque.

In some embodiments, a thickness of adhesive 106 is at most about 5000 μm, at most about 1000 μm, at most about 500 μm, at most about 250 μm, at most about 50 μm, at most about 40 μm, at most about 30 μm, or at most about 25 μm. Additionally, or alternatively, the thickness of adhesive 106 is at least about 5 μm, at least about 10 μm, at least about 15 μm, at least about 20 μm, at least about 50 μm, or at least about 100 μm.

Although glass laminate 100 shown in FIGS. 1-2 comprises a single glass sheet 102 bonded to non-glass substrate 104, other embodiments are included in this disclosure. For example, in other embodiments, a glass laminate comprises a second glass sheet bonded to a second surface of the non-glass substrate opposite the surface to which the glass sheet is bonded (e.g., opposite surface 105 of non-glass substrate 104). Thus, the non-glass substrate is disposed between the glass sheet and the second glass sheet. Each glass sheet can be bonded to the non-glass substrate as described herein with reference to glass sheet 102 and non-glass substrate 104.

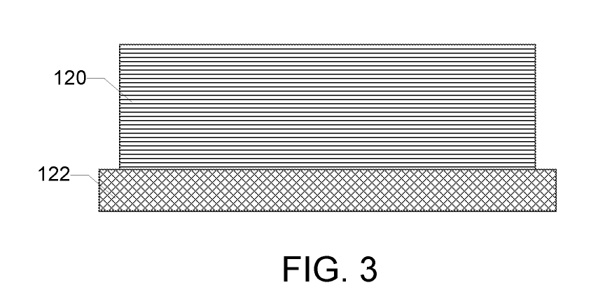

FIGS. 3-5 schematically illustrate some embodiments of a method for forming glass laminate 100. In some embodiments, the method comprises forming an uncured non-glass mat 120 as shown in FIG. 3. Uncured non-glass mat 120 comprises the materials that will be formed into non-glass substrate 104 prior to complete curing. For example, uncured non-glass mat 120 comprises the plurality of polymer impregnated papers prior to complete curing of the polymer. Prior to complete curing, the papers are independent or distinct from one another and not fused into the monolithic or integrated form of non-glass substrate 104. In some embodiments, forming uncured non-glass mat 120 comprises arranging the plurality of polymer impregnated papers into a pile (e.g., by stacking the papers). In some embodiments, the pile is formed on a carrier plate 122 as shown in FIG. 3.

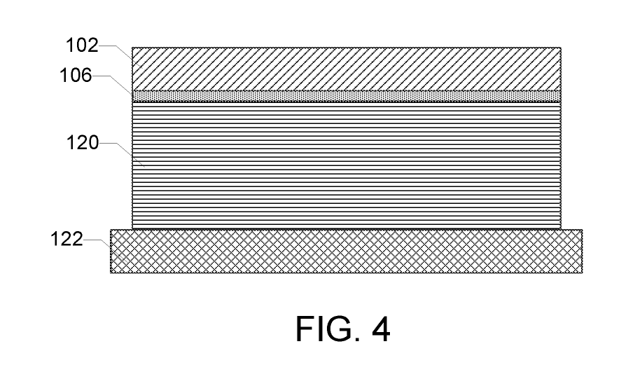

In some embodiments, the method comprises forming a stack comprising uncured non-glass mat 120 and glass sheet 102 as shown in FIG. 4. In some embodiments, forming the stack comprises positioning glass sheet 102 on uncured non-glass mat 120. For example, glass sheet 102 is positioned on the pile comprising the plurality of polymer impregnated papers. In some embodiments, positioning glass sheet 102 on uncured non-glass mat 120 comprises positioning adhesive 106 between the glass sheet and the uncured non-glass mat. For example, adhesive 106 is positioned between glass sheet 102 and the plurality of polymer impregnated papers. In some embodiments, positioning adhesive 106 comprises positioning an adhesive sheet, applying a liquid adhesive, or another suitable application process.

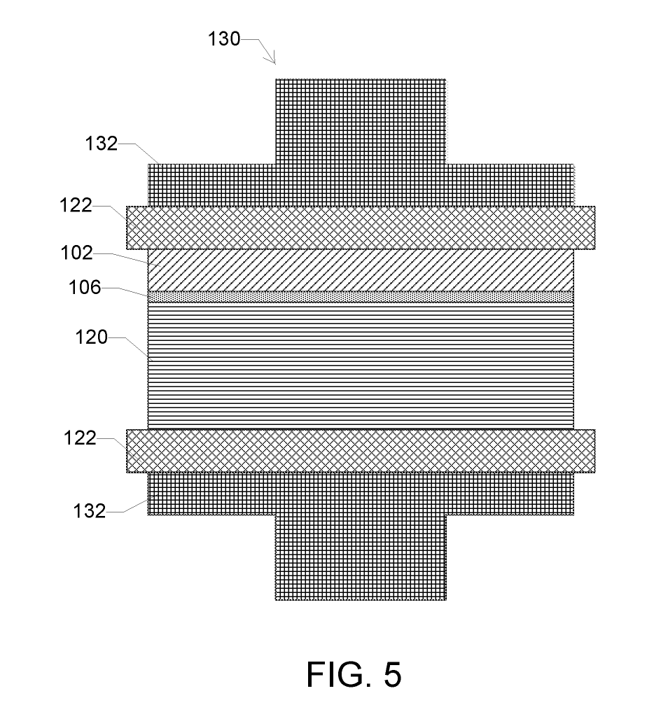

In some embodiments, the method comprises pressing the stack comprising glass sheet 102 and uncured non-glass mat 120 at a pressing pressure and a pressing temperature. In some of such embodiments, the pressing comprises positioning the stack within a press 130 as shown in FIG. 5. For example, press 130 comprises a pair of pressing plates or platens 132 that are movable inward toward one another. The stack is positioned between the pair of platens 132, and the platens are moved inward toward one another to apply pressure to the stack disposed therebetween.

In some embodiments, carrier plates 122 are disposed between the stack and one or both platens 132. Carrier plates 122 can help to prevent the stack from sticking to platens 132. Additionally, or alternatively, a release liner is disposed between the stack and one or both platens 132 (e.g., between the stack and one or both carrier plates 122 and/or between one or both carrier plates 122 and adjacent platens 132). For example, the release liner comprises a super calendered kraft paper (SCK), a glassine, a clay coated kraft paper (CCK), a machine finished kraft paper (MFK), a machine glazed paper (MG), a biaxially oriented polyethylene terephthalate (BOPET) film, a biaxially oriented polypropylene (BOPP) film, a polyolefin film, gypsum powder, or combinations thereof.

Although pressing the stack is described with reference to FIG. 5 as being performed with press 130 comprising a pair of platens 132, other embodiments are included in this disclosure. For example, in other embodiments, one platen is stationary and the other platen is movable inward toward the stationary platen to apply pressure to the stack disposed therebetween. In other embodiments, an autoclave is used to apply pressure to the stack disposed therein. In various embodiments, any suitable equipment can be used to press the stack at the pressing pressure and the pressing temperature.

In some embodiments, the pressing pressure is at least about 1 MPa, at least about 2 MPa, at least about 3 MPa, at least about 4 MPa, at least about 5 MPa, at least about 6 MPa, at least about 7 MPa, at least about 8 MPa, at least about 9 MPa, at least about 10 MPa, at least about 11 MPa, or at least about 12 MPa. Additionally, or alternatively, the pressing pressure is at most about 15 MPa. Additionally, or alternatively, the pressing temperature is at least about 100° C., at least about 120° C., at least about 140° C., at least about 160° C., at least about 180° C., at least about 200° C., at least about 220° C. Additionally, or alternatively, the pressing temperature is at most about 400° C., at most about 350° C., at most about 300° C., at most about 250° C., or at most about 200° C.

In some embodiments, pressing the stack comprises pressing the stack at the pressing pressure and the pressing temperature for a pressing time. For example, the pressing time is at least about 30 minutes or at least about 60 minutes. Additionally, or alternatively, the pressing time is at most about 5 hours, at most about 4 hours, at most about 3 hours, or at most about 2 hours. Although longer pressing times may be used, additional pressing time after that sufficient to cure the uncured non-glass mat to form the non-glass substrate and bond the glass sheet to the non-glass substrate can add processing time without providing substantial benefit.

Upon pressing the stack, uncured non-glass mat 120 is cured and bonded to glass sheet 102 to form glass laminate 100 comprising the glass sheet bonded to non-glass substrate 104. For example, the elevated temperature and pressure during the pressing is sufficient to cure the polymer impregnated in the papers and fuse the papers into a monolithic or integrated non-glass substrate 104 and to bond glass sheet 102 to the non-glass substrate. For example, the method comprises pressing the stack comprising glass sheet 102 and the plurality of polymer impregnated papers at a pressing pressure of at least about 1 MPa and a pressing temperature of at least about 100° C., whereby the glass sheet and the plurality of polymer impregnated papers are bonded to form glass laminate 100.

In some embodiments, the glass sheet and the non-glass substrate are bonded at an elevated temperature (e.g., the pressing temperature) and then the glass laminate cooled (e.g., to room temperature). In some of such embodiments, the non-glass substrate has a higher coefficient of thermal expansion (CTE) than the glass sheet. Thus, as the glass laminate is cooled, compressive stress is generated in the glass sheet. For example, as the glass laminate is cooled, the non-glass substrate tends to shrink more than the glass sheet, generating compressive stress in the glass sheet and tensile stress in the non-glass substrate. Such compressive stress in the glass sheet can increase the strength of the glass sheet, rendering the glass sheet more resistant to damage. Additionally, or alternatively, such compressive stress can enable the glass laminate to be cut (e.g., using mechanical or laser cutting processes) without breaking the glass sheet.

Although uncured non-glass mat 120 described with reference to FIGS. 3-5 comprises the plurality of polymer impregnated papers, other embodiments are included in this disclosure. For example, in other embodiments, the uncured non-glass mat comprises wood fragments dispersed in a binder. For example, the uncured non-glass mat comprises the wood fragments dispersed in the binder prior to complete curing of the binder. Prior to complete curing, the wood fragments are independent or distinct from one another and not fused into the monolithic or integrated form of the non-glass substrate. In some of such embodiments, forming the uncured non-glass mat comprises shaping the wood fragments and binder into a determined shape (e.g., a sheet). The wood fragments and binder can be arranged into the determined shape on a carrier plate. In some embodiments, the glass sheet is positioned on the uncured non-glass mat to form a stack comprising the glass sheet and the uncured non-glass mat. In some of such embodiments, the adhesive is positioned between the glass sheet and the uncured non-glass mat to form the stack. In some embodiments, the stack is pressed at the pressing pressure and the pressing temperature as described herein with reference to FIGS. 1-3. For example, the method comprises pressing the stack comprising the glass sheet and the plurality of wood fragments dispersed in the binder at a pressing pressure of at least about 1 MPa and a pressing temperature of at least about 100° C., whereby the glass sheet and the plurality of wood fragments are bonded to form the glass laminate.

In some embodiments, a plurality of stacks can be pressed simultaneously. For example, adjacent stacks can be separated by a separator plate (e.g., a steel plate), a release liner, and/or a cushion (e.g., layers of kraft paper).

Although the method is described with reference to FIGS. 3-5 as a batch process in which segmented uncured non-glass mats and glass sheets are successively pressed to form segmented glass laminates, other embodiments are included in this disclosure. For example, in other embodiments, the method is a continuous process in which an elongate uncured non-glass mat ribbon and an elongate glass sheet ribbon are continuously pressed at the pressing pressure and the pressing temperature to form an elongate glass laminate ribbon comprising the glass sheet ribbon bonded to a non-glass substrate ribbon. In some embodiments, a plurality of polymer impregnated paper ribbons (e.g., fed from paper rolls) are formed into a pile ribbon (e.g., a pile of polymer impregnated paper ribbons in the form of a ribbon), the glass sheet ribbon (e.g., fed from a glass roll) is applied to the pile ribbon to form a stack ribbon (e.g., a stack of polymer impregnated paper ribbons and the glass sheet ribbon in the form of a ribbon), and the stack ribbon is continuously pressed (e.g., between pressing rollers) at the pressing pressure and pressing temperature to form the glass laminate ribbon. In other embodiments, a plurality of wood fragments dispersed in a binder is formed into an uncured non-glass mat ribbon (e.g., by extrusion), the glass sheet ribbon (e.g., fed from a glass roll) is applied to the uncured non-glass mat ribbon to form a stack ribbon, and the stack ribbon is continuously pressed (e.g., between pressing rollers) at the pressing pressure and pressing temperature to form the glass laminate ribbon. In various embodiments, the glass laminate ribbon can be cut to form segmented glass laminates.

In various embodiments, the non-glass substrate is cured and bonded to the glass sheet in a single pressing process. Such a process negates any need for a separate lamination process to laminate the glass sheet to a previously formed non-glass substrate, which can save time and expense in the glass laminate manufacturing process. Surprisingly, the glass sheet is able to survive the high pressure and temperature to which it is subjected during the process described herein, even when the glass sheet is a flexible glass sheet with a thickness of 0.3 mm or less.

### EXAMPLES

Various embodiments will be further clarified by the following examples.

### Example 1

A glass laminate having the general configuration show in FIG. 1 was formed. A pile was formed by stacking, in order, three 0.9 mm thick core kraft papers impregnated with phenolic resin, one decorated kraft paper impregnated with phenolic resin, and a tissue paper impregnated with melamine resin. The pile was arranged on a steel plate with the core papers at the bottom adjacent to the steel plate and a BOPP release liner positioned between the pile and the steel plate. A stack was formed by positioning a glass sheet on top of the pile with the glass sheet adjacent to the tissue paper and an adhesive sheet disposed between the glass sheet and the pile. The glass sheet was a flexible aluminosilicate glass sheet with a thickness of 0.2 mm commercially available as Corning® Willow® Glass from Corning Incorporated (Corning, N.Y., USA). The adhesive sheet was a 75 μm thick PMMA sheet. A second steel plate was positioned on top of the glass sheet with a second BOPP release liner positioned between the glass sheet and the second steel plate.

The stack between the steel plates was positioned in a press with seven kraft papers positioned between each steel plate and the adjacent press platen as a cushion and gypsum powder positioned between the kraft papers and the platens as a release agent. The temperature of the stack was increased from 60° C. to a pressing temperature of 145° C. over a 15 minute heating time during which the stack was pressed at a pressing pressure of 2 MPa. Following the heating time, the stack was pressed at the pressing pressure of 2 MPa and the pressing temperature of 145° C. for a pressing time of 50 minutes. Following the pressing time, the temperature of the stack was reduced to 60° C. over a 15 minute cooling time during which the stack was pressed at the pressing pressure of 2 MPa. The pressure was released. The glass laminate comprising the glass sheet bonded to the non-glass substrate was removed from the press. The glass sheet survived the pressing process during which the non-glass substrate was cured and bonded to the glass sheet.

### Example 2

A glass laminate having the general configuration show in FIG. 1 was formed. A stack was formed as described in Example 1, except that the glass sheet was a chemically strengthened glass sheet with a thickness of 2 mm commercially available under the trade name Corning® Gorilla® Glass (Corning Incorporated, Corning, N.Y., USA).

The stack between the steel plates was positioned in a press with seven kraft papers positioned between each steel plate and the adjacent press platen as a cushion and gypsum powder positioned between the kraft papers and the platens as a release agent. The temperature of the stack was increased from 60° C. to a pressing temperature of 145° C. over a 15 minute heating time during which the stack was pressed at a pressing pressure of 9 MPa. Following the heating time, the stack was pressed at the pressing pressure of 9 MPa and the pressing temperature of 145° C. for a pressing time of 50 minutes. Following the pressing time, the temperature of the stack was reduced to 60° C. over a 15 minute cooling time during which the stack was pressed at the pressing pressure of 9 MPa. The pressure was released. The glass laminate comprising the glass sheet bonded to the non-glass substrate was removed from the press. The glass sheet survived the pressing process during which the non-glass substrate was cured and bonded to the glass sheet.

### Comparative Example

A glass laminate having the general configuration show in FIG. 1 was formed. A stack was formed as described in Example 1.

The stack between the steel plates was positioned in a press with seven kraft papers positioned between each steel plate and the adjacent press platen as a cushion and gypsum powder positioned between the kraft papers and the platens as a release agent. The temperature of the stack was increased from 60° C. to a pressing temperature of 145° C. over a 15 minute heating time during which the stack was pressed at a pressing pressure of 9 MPa. Following the heating time, the stack was pressed at the pressing pressure of 9 MPa and the pressing temperature of 145° C. for a pressing time of 50 minutes. Following the pressing time, the temperature of the stack was reduced to 60° C. over a 15 minute cooling time during which the stack was pressed at the pressing pressure of 9 MPa. The pressure was released. A glass laminate was not successfully formed because the glass sheet fractured during the pressing process.

Examples 1 and 2 illustrate the surprising result that a glass sheet is able to survive the elevated pressure and temperature associated with forming the non-glass substrate so that the glass sheet can be bonded to the non-glass substrate concurrently with forming the non-glass substrate and without a separate lamination process. The thinner glass sheet of Example 1 was able to survive the lower pressing pressure of 2 MPa, which was sufficient to cure the non-glass substrate and form the glass laminate. The thicker glass sheet of Example 2 was able to survive the higher pressing pressure of 9 MPa to form the glass laminate. However, the Comparative Example illustrates that lower pressing pressures may be appropriate for thinner glass sheets, as the thinner glass sheet of the Comparative Example did not survive the higher pressing pressure of 9 MPa.

It will be apparent to those skilled in the art that various modifications and variations can be made without departing from the spirit or scope of the claimed subject matter. Accordingly, the claimed subject matter is not to be restricted except in light of the attached claims and their equivalents.

1. A method comprising:
pressing a stack comprising a glass sheet and an uncured non-glass mat at a pressing pressure and a pressing temperature, whereby the uncured non-glass mat is cured to form a non-glass substrate and bonded to the glass sheet to form a glass laminate comprising the glass sheet bonded to the non-glass substrate.

2. The method of claim 1, wherein the uncured non-glass mat comprises a plurality of polymer impregnated papers.

3. The method of claim 2, wherein the non-glass substrate is a high pressure laminate material, a low pressure laminate material, or a continuous pressure laminate material.

4. The method of claim 1, wherein the uncured non-glass mat comprises wood fragments dispersed in a binder.

5. The method of claim 4, wherein the non-glass substrate is a chipboard material, a fiberboard material, or a plywood material.

6. The method of claim 1, further comprising positioning an adhesive layer between the glass sheet and the uncured non-glass mat prior to the pressing.

7. The method of claim 6, wherein the adhesive layer comprises a thermoplastic polymer material.

8. The method of claim 1, wherein the glass sheet comprises a flexible glass sheet with a thickness of at most about 0.3 mm.

9. The method of claim 1, wherein the glass sheet comprises a strengthened glass sheet.

10. The method of claim 9, wherein the strengthened glass sheet comprises a chemically strengthened glass sheet with a thickness of about 0.4 mm to about 3 mm.

11. A method comprising:
pressing a stack comprising a glass sheet and a plurality of uncured polymer impregnated papers at a pressing pressure and a pressing temperature, whereby the plurality of uncured polymer impregnated papers is cured to form a non-glass substrate and bonded to the glass sheet to form a glass laminate.

12. The method of claim 11, further comprising positioning the glass sheet on a pile comprising the plurality of uncured polymer impregnated papers prior to the pressing to form the stack comprising the glass sheet and the plurality of uncured polymer impregnated papers.

13. The method of claim 12, wherein the positioning the glass sheet on the pile comprising the plurality of uncured polymer impregnated papers comprises positioning an adhesive layer between the glass sheet and the plurality of uncured polymer impregnated papers.

14. The method of claim 13, wherein the pressing cures the adhesive layer to bond the glass sheet and the non-glass substrate.

15. The method of claim 13, wherein the adhesive layer comprises a thermoplastic polymer material.

16. The method of claim 11, wherein the glass sheet comprises a flexible glass sheet with a thickness of at most about 0.3 mm.

17. The method of claim 11, wherein the glass sheet comprises a strengthened glass sheet.

18. The method of claim 17, wherein the strengthened glass sheet comprises a chemically strengthened glass sheet with a thickness of about 0.4 mm to about 3 mm.
